(19) United States
(12) Patent Application Publication
(10) Pub. No.: US 2026/0229901 A1
(43) Pub. Date: Aug. 6, 2026

(54) ENERGY MANAGEMENT METHOD FOR AN ENERGY SUPPLY DEVICE IN AN ISLAND GRID, AND ENERGY SUPPLY DEVICE

(71) Applicant: Siemens Energy Global GmbH & Co. KG, München (DE)

(72) Inventors: Lukas Riedel, Baiersdorf (DE); Jens Berben, Erlangen (DE); Carsten Nagel, Bargenstedt (DE)

(21) Appl. No.: 19/146,544

(22) PCT Filed: Dec. 11, 2023
(86) PCT No.: PCT/EP2023/085037

§ 371 Date: Jul. 9, 2025

(30) Foreign Application Priority Data
Jan. 19, 2023 (DE) 10 2023 200 396.1

(51) Int. Cl. H02J 3/388; H02J 3/0014; H02J 3/38; H02J 3/48; H02J 3/50; H02J 101/10; H02J 105/10

(52) U.S. Cl. CPC H02J 3/388; H02J 3/00142; H02J 3/381; H02J 3/48; H02J 3/50; H02J 2101/10; H02J 2105/10

(57) ABSTRACT

The invention relates to an energy management method for an energy supply device in an electrical island grid comprising a plurality of parallel-connected energy supply modules, where at least one first parameter of a power provided by each energy supply module is monitored with regard to deviations from a respective target value. The first parameter or a second parameter of the provided power is monitored with regard to fluctuations and the respective energy supply module is shut down on the basis of the deviations and/or fluctuations. The invention also relates to an energy supply device in an electrical island grid comprising a plurality of parallel-connected energy supply modules.

### BACKGROUND

The invention relates to an energy management method for an energy supply device in an island grid, and a corresponding energy supply device.

Dynamic positioning (DP) is a computer-controlled system for the automatic positioning of a ship so that it can hold a position without anchoring or mooring. The DP notation of specialized ships requires an enhanced protection concept for productive diesel generator sets, in order to provide maximum available energy for maintaining the local position. The diesel generators must for this reason, in addition to the usual protective functions covered by the protective device, also be protected by expanded protective functions. The protection can also be used as additional protection in all other ship types. Novel notation, such as OP and ER, will additionally require this protection.

One software solution in these cases monitors the parallel operation of the diesel generators and detects malfunctions in parallel operation, so that the individual grids on-board can remain interconnected provided that no fault is detected and are only disconnected in case of need or the faulty set is then disconnected.

Protective functions that are required for the energy generators by the class are realized in the IEDs (intelligent electronic devices), such as reverse overload power, overcurrent, underfrequency, over- and undervoltage, etc. These faults presuppose that the devices/systems fail (mechanically or electrically) completely. However, there are various fault scenarios in which the entire energy system can hang in an intermediate state. Here, although it is possible to continue to operate the grid, the performance of the grid is possibly lower or undesirable reactions occur in downstream systems.

This problem has hitherto been solved by means of drive feed-ins via redundant busbar solutions and small island operations, i.e. the generators and drives were distributed over a plurality of grids, so the failure of a grid has a small effect on the drive power. However, this solution required a large amount of additional hardware and more diesel generators have to be switched on so that the supply of the grids can be ensured.

In DP notation, the supply grid was hitherto divided into at least two, at most four, island grids, so that only one drive is lost if an island is lost. These islands are then populated at least with three diesel engines and one drive. Alternatively, two main grids can also be defined, which are then disconnected in DP operation, wherein the individual grids can be disconnected one more time in certain fault cases. Here, the entire ship design is to consider and to clarify whether the panels can stand in two or four different rooms.

### SUMMARY

The object of the invention is to provide improved generator protection for an island grid, in which erratic behavior of individual energy supply modules is detected early in order to disconnect same from the interconnected system.

The invention achieves the object directed to a method in that, in the case of such an energy management method for an energy supply device in an island grid with a plurality of parallel-connected energy supply modules, wherein at least one first parameter of a power supplied to each energy supply module is monitored with regard to deviations from a respective setpoint value, the invention provides for the first parameter or a second parameter of the supplied power to be monitored with regard to fluctuations and the respective energy supply module to be switched off depending on the deviations and/or fluctuations.

The invention achieves the object directed to a method in that, in the case of such an energy management method for an energy supply device in an electrical island grid with a plurality of parallel-connected energy supply modules, wherein at least one first parameter of a power supplied to each energy supply module is monitored with regard to deviations from a respective setpoint value, the invention provides for the first parameter or a second parameter of the supplied power to be monitored with regard to fluctuations and the respective energy supply module to be switched off depending on the deviations and/or fluctuations.

The inclusion according to the invention of the fluctuations of the power parameters in addition to the observations of the deviations of setpoint values enables a faster and more reliable reaction to possible problems of individual energy supply modules in the island grid.

In one embodiment, the first parameter and possibly also the second parameter is an active power setpoint value and/or a reactive power setpoint value, i.e. the protection that is expanded according to the invention is composed of monitoring with regard to a deviation of a set from its active power setpoint value- and thus also frequency setpoint value- and a deviation from its reactive power setpoint value- and thus also voltage setpoint value.

Furthermore, if fluctuations relating to frequency, electric voltage, active and reactive power are monitored.

It is expedient in this case that, if the deviation that arises exceeds a parameterizable limit value, an alarm and/or a parameterizable protective function of the corresponding energy supply module is triggered.

In one embodiment of the invention, a difference in successive measured values of the first or second parameter is ascertained, wherein, if the sign of the difference changes and the difference exceeds a parameterizable value, this is counted, wherein, if a parameterizable number of alternating sign changes is determined within a parameterizable time, an alarm is triggered and/or a parameterizable protective function of the corresponding energy supply module is triggered.

In one embodiment, deviations and fluctuations of an energy supply module are compared with deviations and fluctuations of other energy supply modules of the energy supply device in the island grid. Although a consideration of individual energy supply modules that is separated from adjacent energy supply modules has a certain value, it is only possible to monitor the island grid for controller faults if a central component collects all setpoint and actual values of the individual energy supply modules and compares them with one another.

In one embodiment, if a faulty energy supply module is identified and the effect of disconnecting this faulty energy supply module from the island grid is examined. By means of software-assisted algorithms, it is possible to ascertain which energy supply module is causing the problem, report it to an energy management system and possibly disconnect it. By detecting a defect in the energy generation and monitoring the reaction, the availability of the energy grid is increased, as a result of which DP notations can be realized with a lower hardware outlay.

It is expedient in this case if an alternative is sent to an energy management system should it not be possible to disconnect the faulty energy supply module from the energy supply system. In this case, the alternative constellation of the energy supply modules is also checked in advance for plausibility and availability.

The faster a parameter is measured, the faster an energy management system can react to potential faults. In one embodiment, the measurements of at least one parameter of the supplied power of an energy supply module takes place with a temporal resolution of at least 500 ms.

In one embodiment of the invention, an energy supply module is monitored for over- or undersupply of fuel. For this purpose, a calculated power is compared with a current power. If a value exceeds or falls below a first parameterizable deviation of the power from a calculated setpoint value, an alarm is triggered and in the event of a value exceeding or falling below a second parameterizable deviation that is greater than the first parameterizable deviation, a parameterizable protective function of the faulty energy supply module is initiated.

The method according to the invention relates to an energy supply device in an electrical island grid having a plurality of parallel-connected energy supply modules, the energy supply device comprising an energy management system for the open-loop or closed-loop control of the energy supply modules, and a monitoring device which is suitable for measuring power parameters of the energy supply modules, wherein the monitoring device is configured such that it is possible to identify and disconnect a faulty energy supply module from the island grid on the basis of the measured power parameters by means of comparison with parameterizable limit values.

In one embodiment, the monitoring device is configured such that active power and reactive power are measured.

In one embodiment the monitoring device includes at least one island monitoring module and a plurality of in- and output modules, wherein the in- and output modules are arranged in the vicinity of the associated sensors and actuators in the respective energy supply module, are connected to a respective island monitoring module via a bus system and special head assemblies or interface modules, and are configured for collecting setpoint and actual values of the individual energy supply modules and forwarding them to the respective island monitoring module so that the setpoint and actual values of the individual energy supply modules can be compared with one another there and recommended actions can be transmitted to the energy management system. The interface modules have a corresponding bus interface (Profibus, Profinet, etc.). Instead of many individual wires to the central CPU, the sensors and actuators only need to be wired up to the decentralized periphery (i.e. in- and output modules). From there, only one bus line leads to the CPU.

Using the invention, it is possible to increase the availability of an energy supply device in an island grid using a plurality of parallel-connected energy supply modules. In other words, the invention enables a combination of the hitherto separate islands and thus a reduction of the ongoing diesel requirement. Therefore, there is a hardware saving, as there is no longer a requirement for so many islands and space, which is required for the hardware, is saved, and fuel is saved during operation, as this makes it possible to reduce the amount of diesel required.

Finally, the invention enables closed bus-tie operation, i.e. operation of the energy supply device using a closed busbar which has a higher tolerance for faults in the dynamic positioning (DP) of a ship for example. Without the invention, in the case of a ship that is operated with closed second switches, the continued operation of drives would not be ensured in the event of particular types of power outages. Fast restoration of the plant is often of decisive importance however, in order to fulfill DP2 and DP3 minimum requirements, which is why open busbars are often used.

### BRIEF DESCRIPTION OF THE DRAWINGS

The invention is explained in more detail by way of example with reference to the drawings. In the figures, schematically and not true to scale:

FIG. 1 shows an electrical grid according to the prior art,

FIG. 2 shows a further electrical grid according to the prior art,

FIG. 3 shows an electrical grid having an energy supply device according to the invention,

FIG. 4 shows an energy supply device according to the invention,

FIG. 5 shows a flowchart for ascertaining a counter reading based on the example of active power hunting for an individual energy generator module,

FIG. 6 shows further actions as a function of a counter reading,

FIG. 7 shows the determination of a faulty energy supply module,

FIG. 8 shows the monitoring of an energy supply module for an over- or undersupply of fuel,

FIG. 9 shows the evaluation of the deviation for each individual energy supply module, e.g. caused by over-/undersupply, and

FIG. 10 shows the logic of a protective function in the event of an over- or undersupply of fuel.

### DETAILED DESCRIPTION

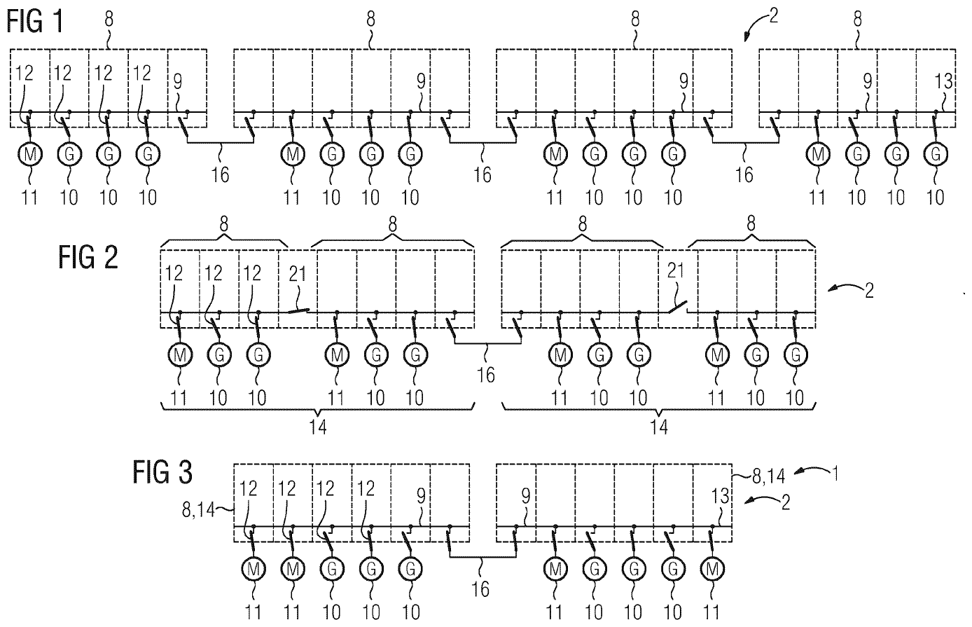

FIG. 1 shows an electrical island grid 2 having an energy supply device according to the prior art in a schematic and exemplary manner. In the example of FIG. 1, it comprises four islands 8 each having one island busbar 9, by means of which the three generators 10 and one engine 11 in each case can be electrically connected. First switches 12 are provided for this purpose. The island busbars 9 can be interconnected or disconnected from one another by means of second switches 16. In DP (dynamic positioning) operation, all second switches 16 are open, i.e. the island grid 2 then operates with a completely open busbar 13.

FIG. 2 shows a further electrical island grid 2 having an energy supply device according to the prior art, in which two main grids 14 are defined, which are disconnected from one another in DP operation. These main grids 14 can be separated further into islands 8 in certain fault cases. In the present exemplary embodiment of FIG. 2, these each contain two generators 10 and one engine 11.

FIG. 3 shows an electrical island grid 2 having an energy supply device 1 according to the invention, having a busbar 13, which only has one other single second switch 16, using which the island busbars 9 of the islands 8 can be interconnected or disconnected from one another. In the example of the embodiment of FIG. 3, the two islands 8 correspond to two main grids 14. The number of engines 11 and generators 10 required is reduced compared to the configurations of FIGS. 1 and 2 from the prior art.

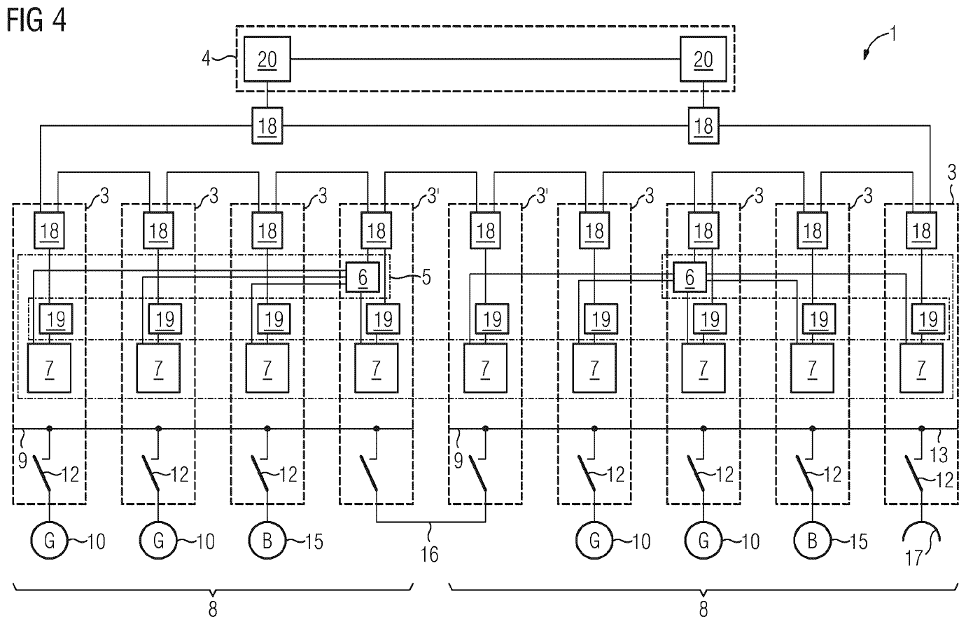

FIG. 4 shows an energy supply device 1 according to the invention, as could be used for example in the electrical island grid 2 of FIG. 3. The energy supply device 1 extends across two main grids 14 or islands 8. Both main grids 14 each comprise two generators 10 and one battery 15, which are connected via first switches 12 to the respective island busbar 9 or the busbar 13. The two main grids 14 can be connected or disconnected by means of the second switch 16. The right main grid 14 further comprises a shore connection 17. The exemplary embodiment of FIG. 4 therefore comprises seven energy supply modules 3. The two further modules 3′ right at the second switch 16 are interfaces between the islands 8, but although they are not used for energy generation, they should likewise be included in the monitoring of the energy supply device 1.

An energy supply module 3 comprises a network module 18 which is used as an interface to a data network of the inventive energy supply device 1, which data network is not mentioned in any more detail. Furthermore, an energy supply module 3 comprises a local energy management module 19 which is connected to the network module 18 for transmitting data.

The local energy management module 19 is also connected to an in- and output module 7 which enables communication for example with sensors which are arranged in the respective energy supply module 3. Such an in- and output module 7 can both receive signals and send outputs. For the invention, it is important that the in- and output modules 7 of the energy supply modules 3 of an island 8 are connected to an island monitoring module 6. An island monitoring module 6 can, as shown in the exemplary embodiment of FIG. 4, itself be arranged in an energy supply module 3 or a further module 3, but it does not have to be. It also fulfills its function outside of the energy supply modules 3 or the further modules 3.

According to the invention, at least one first parameter of a power supplied to each energy supply module 3 is monitored with regard to deviations from a respective setpoint value, wherein the first parameter or a second parameter of the supplied power is monitored with regard to fluctuations and the respective energy supply module 3 is switched off depending on the deviations and/or fluctuations.

The first or second parameter is an active power setpoint value (active power) or a reactive power setpoint value (reactive power). In particular, fluctuations relating to frequency, electric voltage, active and reactive power are monitored.

The monitoring of the active power can take place by means of an internal setpoint value of the energy supply device 1 or an energy supply module 3 and the actual value measured by means of a transducer at the generator terminals.

For monitoring the reactive power, a setpoint value of an AVR (automatic voltage regulator) and a suitable value that is measured at the generator terminals are required.

If a deviation of the actual value from the setpoint value is determined, which exceeds a parameterizable limit, an alarm is triggered and a parameterizable protective function of the defective energy supply module is initiated.

To check whether what is known as “frequency hunting” or “active power hunting” is present, alternating changes per unit time should be added up. “Hunting” refers to a process in which a system searches or “hunts” an equilibrium position, which is shown in the present case as oscillation of a frequency or an active power for example.

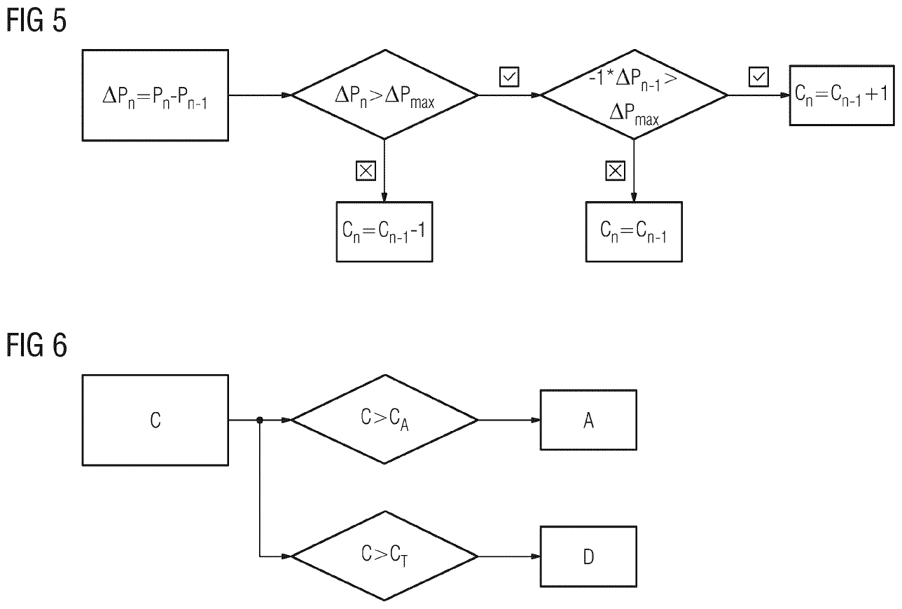

FIG. 5 shows how that takes place based on the example of active power hunting for an individual energy supply module 3, for example a generator set. The active power of the energy supply module 3 is measured by means of the fastest available option, for example by means of the transducer at the generator terminals. The resolution here is approx. 100 ms. In the flowchart of FIG. 5, the slope of the power curve is determined by the difference from the previous value being calculated in each cycle:

$$Δ {P}_{n} = {P}_{n} - {P}_{n - 1}$$

where ΔPₙ=slope of the power curve, Pₙ=currently measured power value and Pₙ₋₁=directly preceding power value.

This slope ΔPₙ can be positive, negative or 0. If the slope is within permitted limits, a counter is reduced by 1 (Cₙ=Cₙ₋₁−1). If the slope is greater than a limit value (ΔPₙ>ΔPₘₐₓ) however, the counter is increased by 1 (Cₙ=Cₙ₋₁+1) every time the direction of the difference changes and the difference exceeds a parameterizable magnitude.

If a parameterizable number of alternating instances of exceeding is determined within a parameterizable time, a “frequency/active power hunting” alarm is triggered and a parameterizable protective function of the corresponding energy supply module 3 is triggered. In the example of FIG. 6, two actions are initiated on the basis of the number of alternating instances of exceeding. In the upper path (C>C_{A}) an alarm is triggered, in the lower path (C>C_{T}) a trigger takes place for the determination of a faulty or defective (D) energy supply module 3.

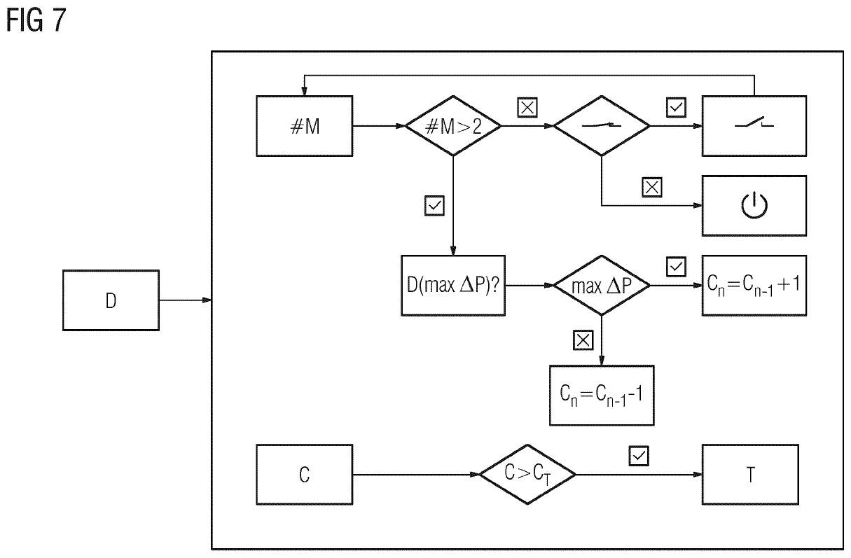

FIG. 7 shows the necessary steps. First, the number of active energy supply modules (#M) is determined. If there are more than two energy supply modules 3 on the grid (#M>2), it is possible to detect the defective energy supply module 3 in that the deviation of this defective energy supply module 3 divides to the other energy supply modules 3, i.e. the deviation is greatest in the case of the defective energy supply module 3. If there are more than two energy supply modules 3 per island 8, the one that has the strongest deviation is therefore identified. In this one, a fault counter is increased (Cₙ=Cₙ₋₁+1) and the respective fault counters of the remaining energy supply modules 3 are reduced (Cₙ=Cₙ₋₁−1). In order to have this comparison option, one island monitoring module 6 is provided for each island 8 as central component which monitors the deviation of all energy supply modules 3 collectively.

If the number of active energy supply modules is 2 or less, the position of the first switch 16 is checked. If the first switch 16 is closed, an attempt is first made to add a further energy supply module 3, in order to identify the faulty energy supply module by means of the same, as described in the preceding paragraph. If it is not possible to add a further energy supply module 3 or this does not lead to success, the first switch 16 is opened. If it is already open, it may be necessary to start a further energy supply module 3 and add it to the active part of the energy supply device 1 if a requested power is achieved, i.e. in the case of a suitable speed and suitable voltage, while the faulty energy supply module 3 is switched off. A blackout in such a case would be in the order of magnitude of seconds and is only used for correction.

If the fault counter (C) of an energy supply module 3 exceeds a specified fault limit (C_{T}), this energy supply module 3 is switched off, as the lower area of FIG. 7 shows.

The same principle also applies for the monitoring of voltage hunting. Therefore, the reactive power of every energy supply module 3 should be monitored. For this, a fastest possible measurement of the reactive power at the generator terminals is typically required.

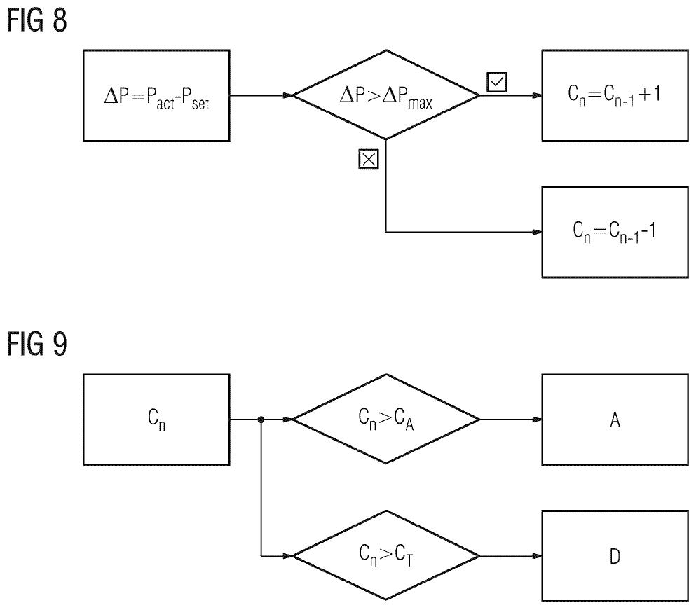

FIG. 8 shows the monitoring of an energy supply module 3, for example an engine (diesel set) 11, for an over- or undersupply of fuel. For this, the position of the filling rod is input via an analog input. The associated signal comes from the corresponding engine 11. This is then converted into an expected generator power by means of a characteristic. This calculated generator power (Pₛₑₜ) is then compared with the current power (P_{act}) at the generator terminals, which is likewise input via an analog input of a transducer.

$$Δ P = {P}_{act} - {P}_{set}$$

If the deviation (ΔP) exceeds a parameterizable maximum value (ΔPₘₐₓ), a counter for the deviations is increased:

$${C}_{n} = {C}_{n - 1} + 1$$

In the case of deviations smaller than the maximum value, the counter is correspondingly reduced.

$${C}_{n} = {C}_{n - 1} - 1 , ( ∀ {C}_{n - 1} > 0 )$$

In the event of a parameterizable number of deviations of the nominal power of the generator 10, an “overfueling” or “underfueling” alarm is triggered. If a value exceeds or falls below a further parameterizable limit, a parameterizable protective function of the faulty set is initiated.

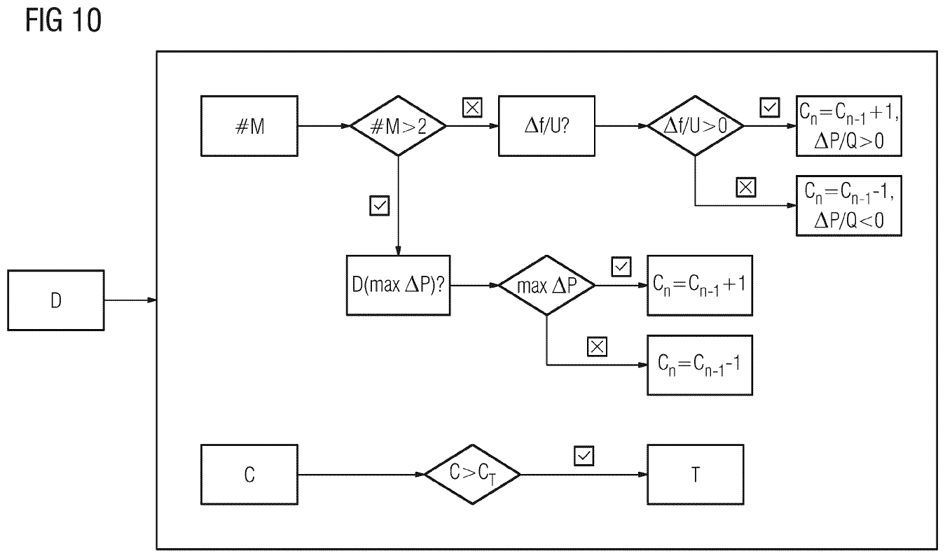

The logic of this protective function is illustrated in FIG. 10 and strongly resembles the procedure shown in FIG. 7.

As in FIG. 7, in the example of FIG. 10, the number of energy supply modules 3 (#M) in the island grid is first determined. As soon as there are more than two energy supply modules 3 on the grid, it is possible in turn to detect the faulty energy supply module 3 in that the deviation of the faulty energy supply module 3 divides to the other energy supply modules 3, i.e. the deviation is greatest (max ΔP) in the case of the defective energy supply module 3. If there are more than two energy supply modules 3 in the island grid, the one that has the strongest deviation is therefore identified. In this one, a fault counter is increased (Cₙ=Cₙ₋₁+1) and the fault counters of the remaining energy supply modules 3 are reduced (Cₙ=Cₙ₋₁−1, ∀ Cₙ₋₁>0).

If the number of energy supply modules is 2 or less, a check is made of whether there is a deviation in the ratio of frequency (f) to voltage (U). If there is a positive deviation in the ratio of frequency to voltage (Δ f/U>0), the trip counter (Cₙ) of the energy supply module 3 with a positive deviation of active power P to reactive power Q (Δ P/Q>0) is increased by one counter (Cₙ=Cₙ₋₁+1). If there is a negative deviation in the ratio of frequency to voltage (Δ f/U>0), the trip counter (Cₙ) of the energy supply module 3 with a negative deviation of active power P to reactive power Q (Δ P/Q<0) is reduced by one counter (Cₙ=Cₙ₋₁−1, ∀ Cₙ₋₁>0).

If the fault counter (Cₙ) of an energy supply module 3 exceeds a specified fault limit (C_{T}), this energy supply module 3 is switched off, as the lower area of FIG. 10 shows (and FIG. 7 has already shown).

1. An energy management method for an energy supply device in an electrical island grid with a plurality of parallel-connected energy supply modules, wherein at least one first parameter of a power supplied to each energy supply module is monitored with regard to deviations from a respective setpoint value, wherein the first parameter or a second parameter of the supplied power is monitored with regard to fluctuations and the respective energy supply module is switched off depending on the deviations and/or fluctuations.

2. The energy management method as claimed in claim 1, wherein the first or second parameter is an active power setpoint value or a reactive power setpoint value.

3. The energy management method as claimed in claim 1, wherein fluctuations relating to frequency, electric voltage, active and reactive power are monitored.

4. The energy management method as claimed in claim 1, wherein, if the deviation that arises exceeds a parameterizable limit value, an alarm and/or a parameterizable protective function of the corresponding energy supply module is triggered.

5. The energy management method as claimed in claim 1, wherein a difference in successive measured values of the first or second parameter is ascertained, wherein, if a sign of the difference changes and the difference exceeds a parameterizable value, this is counted, wherein, if a parameterizable number of alternating sign changes is determined within a parameterizable time, an alarm is triggered and/or a parameterizable protective function of the corresponding energy supply module is triggered.

6. The energy management method as claimed in claim 1, wherein deviations and fluctuations of an energy supply module are compared with deviations and fluctuations of other energy supply modules in the island grid.

7. The energy management method as claimed in claim 1, wherein a faulty energy supply module is identified and an effect of disconnecting this faulty energy supply module from the island grid is examined.

8. The energy management method as claimed in claim 7, wherein an alternative is ascertained should it not be possible to disconnect the faulty energy supply module.

9. The energy management method as claimed in claim 1, wherein measurements of at least one parameter of the supplied power of an energy supply module takes place with a temporal resolution of at least 500 ms, in particular 200 ms.

10. The energy management method as claimed in claim 1, wherein an energy supply module is monitored for over- or undersupply of fuel, wherein a calculated power is compared with a current power, and if a value exceeds or falls below a first parameterizable deviation of the power from a calculated setpoint value, an alarm is triggered and in an event of a value exceeding or falling below a second parameterizable deviation that is greater than the first parameterizable deviation, a parameterizable protective function of a faulty energy supply module is initiated.

11. An energy supply device in an electrical island grid having a plurality of parallel-connected energy supply modules, the energy supply device comprising:
an energy management system for the open-loop or closed-loop control of the energy supply module; and
a monitoring device which is suitable for measuring power parameters of the energy supply modules,
wherein the monitoring device is configured to identify and disconnect a faulty energy supply module from the island grid on the basis of the measured power parameters by means of comparison with parameterizable limit values.

12. The energy supply device as claimed in claim 11, wherein the monitoring device is configured such that active power and reactive power are measured.

13. The energy supply device as claimed in claim 11, wherein the monitoring device comprises at least one island monitoring module and a plurality of in- and output modules, wherein the in- and output modules are arranged in the respective energy supply module and are configured for collecting setpoint and actual values of the individual energy supply modules and forwarding them to the respective island monitoring module so that the setpoint and actual values of the individual energy supply modules can be compared with one another there and recommended actions can be transmitted to the energy management system.
